(19) United States
(12) Patent Application Publication
(10) Pub. No.: US 2015/0214735 A1
(43) Pub. Date: Jul. 30, 2015

(54) SOURCE TO PROVIDE A REDUNDANT OUTPUT TO A CONVERTER

(71) Applicant: Hewlett-Packard Development Company, L.P., Houston, TX (US)

(72) Inventors: Daniel Humphrey, Cypress, TX (US); Mohamed Amin Bemat, Cypress, TX (US)

(73) Assignee: Hewlett-Packard Development Company, L.P., Houston, TX (US)

(21) Appl. No.: 14/404,315

(22) PCT Filed: May 30, 2012
(86) PCT No.: PCT/US2012/040030

§ 371 Date: Nov. 26, 2014

(51) Int. Cl. H02J 1/08; H02M 3/02

(52) U.S. Cl. CPC H02J 1/08; H02M 3/02

(57) ABSTRACT

Examples disclose a system with a first source including a first output to provide input power to a first converter and a second output to provide input power to a second converter. The second output provides input power that is redundant to the first output of the first source.

### BACKGROUND

As technology increases, there is a greater dependence on providing reliability within a power supply system. Increasing the reliability in the power system may provide for situations in which one of the input power sources fail. This protects computers and systems when an unexpected power disruption occurs potentially causing data loss and/or business disruption.

### BRIEF DESCRIPTION OF THE DRAWINGS

In the accompanying drawings, like numerals refer to like components or blocks. The following detailed description references the drawings, wherein:

FIG. 1 is a block diagram of an example system including a first source to provide input power on a first output to a first converter and a second output to provide power redundant to the first output to a second converter;

FIG. 2 is a block diagram of an example system including a first source and a second source to provide first outputs and second outputs to a first converter and a second converter, the outputs are managed by a controller based on a first and a second switch;

FIG. 3 is a block diagram of an example source including a first switch, a first capacitor, a second switch, and a second capacitor to provide a primary output to a first converter and a redundant output to a second converter to achieve a load;

FIG. 4 is a flowchart of an example method performed on a computing device to receive power by a first converter from either a first output of a first source or a second output of a second source and to receive power by a second converter from either a second output of the first source or a first output of the second source; and

FIG. 5 is a flowchart of an example method performed on a computing device to receive power by a first converter and a second converter from either a first source or a second source and detect a fault based on measurements from the first source and the second source.

### DETAILED DESCRIPTION

Providing reliability in a power system enables the system to prepare for a power failure situation. One solution provides power sources directly to the converters. In this solution, each power source supplies output directly to each converter to power a load. This solution is inefficient and decreases reliability as there is no redundancy to assist in a power failure. For example, one power supply may directly supply power to a converter, so when the power supply fails, there is no back-up system to enable power to continue to be supplied to the converter. In this solution, the power system will suffer a power disruption as the corresponding converter will no longer receive power from the affected power source.

In another solution, redundant power supplies provide power to a single converter. This solution uses one power supply to power the converter, and the second power supply as a back-up in case the first power supply fails. However, this solution increases the cost and size of the system as two power supplies provide power to the single converter. Additionally, this solution provides no isolation between the power supplies, and thus may cause a power supply failure from one power supply to the other power supply. For example, current may leak from one power source to another causing the power supplies to cease functioning.

To address these issues, example embodiments disclosed herein provide a system with a first source with a first output to provide input power to a first converter and a second output to provide input power redundant to the first output to a second converter. Providing redundant input power to the second converter by the first source increases reliability of the power system in the situation a second power source supplying power to the second converter fails. Further, this example embodiment decreases costs and the size of the power system by utilizing the first source to provide power to two or more converters.

In another embodiment, the system includes a second source with a first output to provide input power to the second converter and a second output to provide input power to the first converter. The second output of the second source provides input power redundant to the first output of the second source. In this embodiment, if one source fails, the input power can be skewed to the other source to provide to the first and the second converters. This further increases reliability in case either source fans, the converters will still receive power allowing the power system to operate without disruption.

Additionally, the system provides the first source to include a first switch and a second source to include a second switch. Including the switches within the sources provides isolation between the first source, the second source, and/or other electrical components such that it obstructs the path of current to flow between the power sources and/or these other electrical components. This increases the power density of the power system and increases reliability by preventing current leakage from one power source to other electrical components.

In a further embodiment, the system includes a controller to detect a fault at either the first source or the second source and alternate the input power provided to the first and the second converter, between the first source and the second source based on the first switch within the first source and the second switch within the second source. In this embodiment, the controller manages the sources providing input power to the converters. The controller manages the modes of operation between the sources and the converters, such as a balanced mode where the sources each provide an equal amount of input power to the converters or a skewing mode where if a source fans, the non-faulted source supplies the input power. Utilizing a controller to detect the fault and to then alternate input power to the converters enables the power system to operate efficiently even though one of the sources may have faulted and/or failed. Alternating the input power between the sources maintains efficiency and power density. For example, reliability is increased by preventing a system failure when one of the sources experiences a failure, then the system can skew power to the non-faulted power source. Also, including switches within the first and the second source, provides isolation in the power system even though other system components such as the power supply may be non-isolated.

In summary, example embodiments disclosed herein provide redundant power to converters to increase power density and reliability while also reducing the size of the system. Further, the example embodiments disclosed herein provides current isolation to prevent current leakage among the electrical components in the power system.

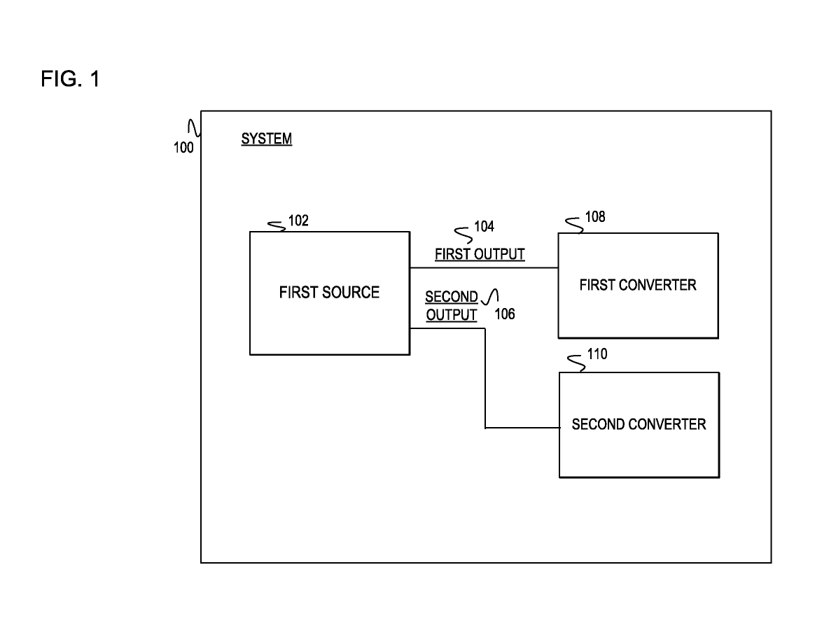

Referring now to the drawings, FIG. 1 is a block diagram of an example system 100 including a first source 102 to provide input power to a first converter 108 on a first output 104. The first source 102 also provides input power to a second converter 110 on a second output 106. The second output 106 provides input power that is redundant of the first output 104. For example, the first output 104 may include 750 W delivered to the first converter 108, then the second output 106 includes 750 W delivered to the second converter 110. Embodiments of the system 100 include a power supply system, computing device, computing system, server, distributed power system, or any other power system suitable to support the first source 102, the first converter 108, and the second converter 110.

The first source 102 provides power on the first output 104 to the first converter 108 and provides power redundant to the first output 104 on the second output 106 to the second converter 110. The first source 102 may be rated for more power than is delivered by the first output 104. This enables the second output 106 to deliver power that is redundant to the first output 104. For example, the first source 102 may be rated for 1500 W, thus the first output 104 includes 750 W and the second output 106 includes 750 W. In one embodiment, the first source 102 is connected in parallel with a second source. This embodiment is explained in further detail in the next figure. Embodiments of the first source 102 include a power supply, energy storage, battery, fuel cell, generator, alternator, solar power, electromechanical supply, converter, rectifier, a power factor correcting module, a power rectifier, circuit logic, DC to DC converter module, or other source capable of providing the first output 104 and the second output 106 to the first converter 108 and the second converter 110.

The first output 104 is a channel which transmits electrical energy (i.e., input power) from the first source 102 to the first converter 108. The input power transmitted by the first output 104 is the electrical energy provided to the first converter 108 and as such, embodiments of this power may include current, voltage, electrical charge, or other type of electrical energy provided by the first source 102 to the first converter 108. In another embodiment, the first output 104 includes a primary output from the first source 102.

The first converter 108 is an electrical device which receives power from the first source 102 on the first output 104 and converts the power to achieve a load. In another embodiment, the first converter 108 receives power from a second output from a second source. This embodiment is explained in detail in the next figure. Embodiments of the first converter 108 include a voltage converter, electronic converter, direct current (DC) to DC converter, or other type of converter capable of receiving the first output 104 from the first source 102.

The second output 106 provides power redundant of the first output 104 to the second converter 110. In this embodiment if another source fails that may provide input power to the second converter 110, the redundant output 106 may be used to power the second converter 110 so the power system 100 may operate without interruption. The second output 106 provides a similar amount or duplicate amount of input power to the second converter 110 that the first output 104 is providing to the first converter 108. For example, if the power system 100 is a 1500 W power system, the first output 104 may provide 750 W and the second output 106 provides 750 W. Providing the redundant output 106 (i.e., the second output) increases the reliability of the power system 100 and also enables the use of fewer sources 102. The second output 106 may be similar in structure and functionality to the first output 104.

The second converter 110 is an electrical device which receives power from the first source 102 on the second output 106 and converts the power to the load. In one embodiment, the second converter 110 receives power from a second source on a first output. In another embodiment, the first converter 108 and the second converter 110 are connected in parallel with each other. These embodiments are explained in detail in the next figure. Embodiments of the second converter 110 include a voltage converter, electronic converter, direct current (DC) to DC converter, or other type of converter capable of receiving the second output 106 from the first source 102.

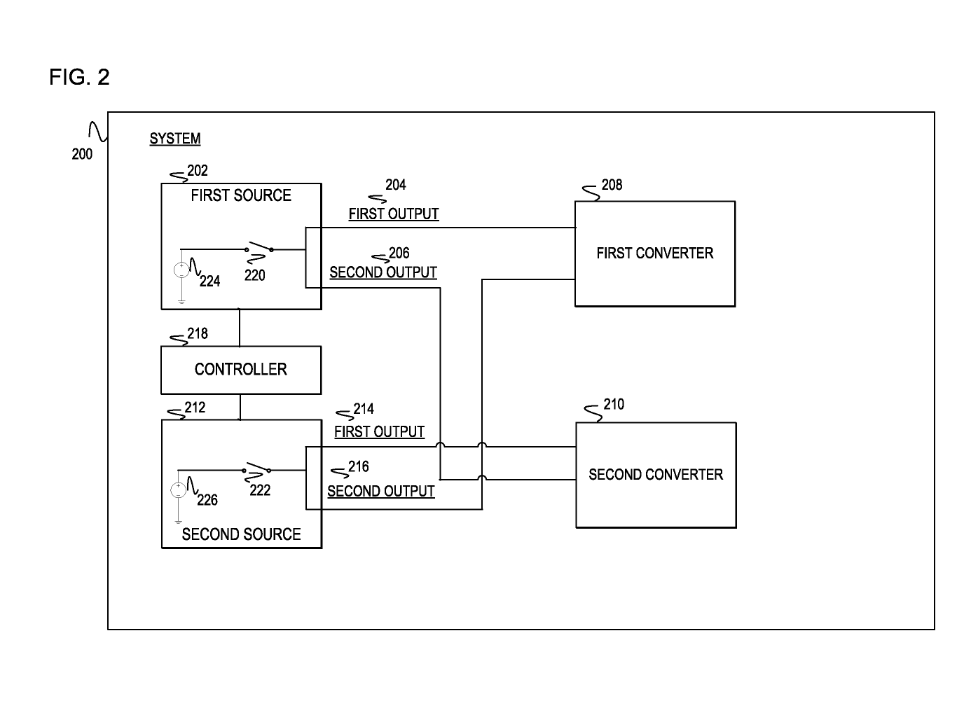

FIG. 2 is a block diagram of an example system 200 including a first source 202 and a second source 212 to provide first outputs 204 and 214 to a first converter 208 and a second converter 210. Additionally, the system 200 provides the second outputs 206 and 216 to provide power that is redundant of the respective first outputs 204 and 214 to the converters 208 and 210. Further, the system 200 includes a controller 218 to manage a first switch 220 and a second switch 222 to provide input power to the converters 208 and 210 on the outputs 204, 206, 214, and 216. The system 200 may be similar in structure and functionality to the system 100 as in FIG. 1.

The first source 202 includes the first power source 224 to provide current through the first switch 220 so when the switch 220 is connected, the first source 202 transmits input power on the first output 204 and the second output 206 to the converters 208 and 210. In one embodiment, the first source 202 is connected in parallel with the second source 212 through the outputs 204, 206, 214, and 216. In another embodiment, the first source 202 may include more than one switch 220. This embodiment is depicted in detail in the next figure. The first source 202 may be similar in structure and functionality to the first source 102 as in FIG. 1. The first output 204 and the second output 206 may be similar in structure and functionality to the first output 104 and the second output 106 as in FIG. 1.

The first converter 208 and the second converter 210 receive input power from the first source 202 and/or the second source 212. In one embodiment, the first source 202 supplies power to the first converter 208 while the second source 212 supplies power to the second converter 210. In this embodiment, the second outputs 206 and 216 would not be utilized to provide power as the sources 202 and 212 would be without a fault and/or failure. In another embodiment, the first converter 208 receives input power from either the first source 202 on the first output 204 or from the second source 212 on the second output 216. In this embodiment, the second converter 210 receives input power from either the second output 206 of the first source 202 or the first output 214 of the second source 212. In a further embodiment, the first converter 208 and the second converter 210 are connected in parallel with each other through outputs 204, 206, 214, and 216 received by the first source 202 and the second source 212. The first converter 208 and the second converter 210 may be similar in structure and functionality to the first converter 108 and the second converter 110 as in FIG. 1.

The second source 212 includes the second power source 226 to provide voltage across the second switch 222. Once the second switch 222 is connected, power is transmitted on the first output 214 and the second output 216 to the converters 208 and 210. In one embodiment, the second source 212 may contain multiple switches to control power transmitted on the outputs 214 and 216. The second source may be similar in functionality and structure of the first source 202 and as such, embodiments of the second source 212 includes a power supply, energy storage, battery, fuel cell, generator, alternator, solar power, electromechanical supply, converter, rectifier, a power factor correcting module, a power rectifier, circuit logic, DC to DC converter module, or other source capable of providing the first output 214 and the second output 216 to the first converter 208 and the second converter 210.

The first output 214 and the second output 216 of the second source 212 transmit input power to the converters 208 and 210. The first output 214 is considered the primary output in that it transmits power directly to the second converter 210. The second output 216 is considered the redundant output as it transmits power identical to the first output 214 of the second source 212 to the first converter 208 when the first source 202 has suffered a fault and/or failure. The first output 214 and the second output 216 may be similar in structure and functionality of the first output 204 and the second output 206.

The controller 218 communicates with the first source 202 and the second source 212 to manage the switches 220 and 222 and alternate power provided on the outputs 204, 206, 214, and 216 to the converters 208 and 210. In one embodiment, the controller 218 detects a fault at either the first source 202 or the second source 212 based on measurements from these sources 202 and 212. In another embodiment, the controller 218 alternates the input power provided to the first converter 208 and the second converter 210 between the first source 202 and the second source 212 based on the first switch 220 within the first source 202 and the second switch 222 within the second source 212. In this embodiment, the controller 218 transmits signals to the sources 202 and 212 to connect and/or disconnect the switches 220 and 222. Additionally, in this embodiment, the controller 218 manages the outputs 204, 206, 214, and 216 to the converters 208 and 210. For example, the controller 218 may detect a fault at the first source 202 and accordingly, transmit the signal to disconnect the switch 220 from the power source 224 so the outputs 204 and 206 are without power. Embodiments of the controller 218 include a processor, circuit logic, a set of instructions executable by a processor, a microchip, chipset, electronic circuit, microprocessor, semiconductor, microcontroller, central processing unit (CPU), graphics processing unit (CPU), visual processing unit (VPU), or other device capable of managing the first source 202 and the second source 212 based on the first switch 220 and the second switch 222.

The first switch 220 is an electrical component within the first source 202 that breaks the connection in the system 200 on the outputs 204 and 206 from the first source 202 to the power source 224. This interrupts the flow of current form the power source 224 to the converters 208 and 210. Embodiments of the first switch 220 include an electromechanical switch, electrical switch, transistor, thyristor, semiconductor device, or other type of electrical device to provide isolation from the first source 202 to the rest of the system 200.

The first power source 224 is a device that supplies current through the first switch 220 to enable the outputs 204 and 206 of the first source 202 to transmit input power to the converters 208 and 210. Although the first power source 224 is included as part of the first source 202, this was done for illustration purposes rather than for limitation purposes. For example, in one embodiment, the first power source 224 may be provided within the first source 202, while in another embodiment, the first power source 224 is provide externally to the first source 202 to transmit power to the first source 202 to transmit power on the outputs 204 and 206. Embodiments of the first power source 224 include a power supply, energy storage, battery, fuel cell, generator, alternator, solar power, electromechanical supply, or other power supply capable of providing current through the first switch 220.

The second switch 222 is an electrical component included in the second source 212 that breaks the connection to the second source 212 to transmit power on the outputs 214 and 216. This interrupts the flow of current from the second power source 226 to the converters 208 and 210. The first switch 220 and the second switch 222 provide current isolation between the first source 202 and the second source 212 to prevent current leakage between the sources 202 and 222. The second switch 222 may be similar in structure and functionality to the first switch and as such, embodiments of the second switch 222 include an electromechanical switch, electrical switch, transistor, thyristor, semiconductor device, or other type of electrical device to provide isolation from the second source 212 to the rest of the system 200.

The second power source 226 is a device that supplies current through the second switch 222 to enable the outputs 214 and 216 to transmit power to the converters 208 and 210. Although the second power source 226 is included as part of the second source 212, this was done for illustration purposes rather than for limitation purposes. For example, in one embodiment, the second power source 226 may be provided within the second source 212, while in another embodiment, the second power source 226 is provided externally to the second source 212 and provides power to the second source 212 to transmit power on the outputs 214 and 216. The second power source 226 may be similar in structure and functionality to the first power source 224 and as such, embodiments of the second power source 226 include a power supply, energy storage, battery, fuel cell, generator, alternator, solar power, electromechanical supply, or other power supply capable of providing current through the second switch 222.

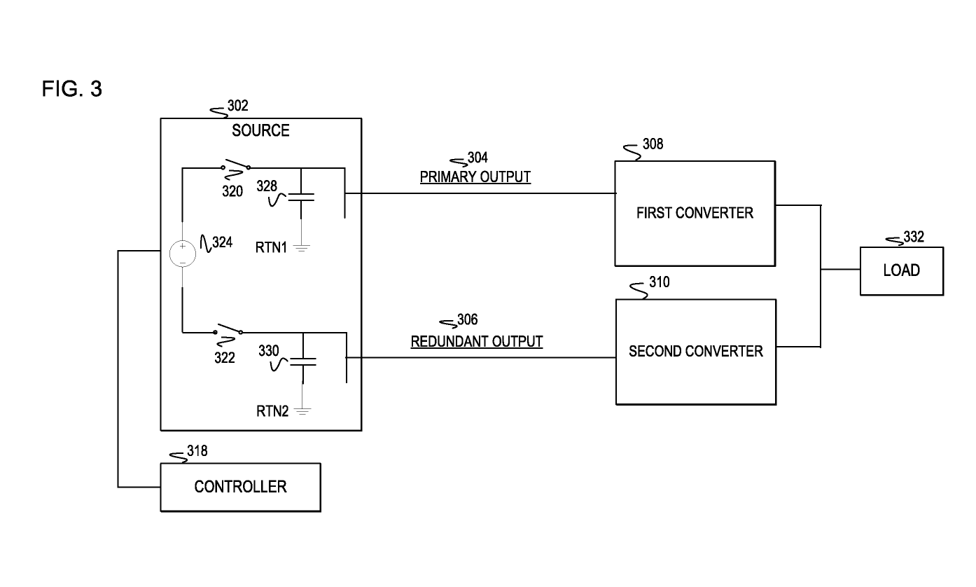

FIG. 3 is a block diagram of an example source 302 including a power source 324, a first switch 320 and a second switch 322 managed by the controller 318 to provide input power to the first capacitor 328 and the second capacitor 330 to transmit input power on a primary output 304 to a first converter 308 and on a redundant output 306 to a second converter 310 to achieve a load 332. The source 302 may be similar in structure and functionality of the source 102 and 202 as in FIGS. 1-2.

The controller 318 operates in conjunction with the source 302 to manage the switches 320 and 322. In one embodiment, the controller 318 detects a fault within the source 302 and transmits a signal to the source 302 to disconnect the switches 320 and 322. The controller 318 may be similar in structure and functionality of the controller 218 as in FIG. 2.

The power source 324 provides power through the switches 320 and 322 to charge the capacitors 328 and 330 to provide power on the outputs 304 and 306. The power source 324 may be similar in structure and functionality to the power source 224 as in FIG. 2.

The first switch 320 and the second switch 322 within the first source 302 may connect and/or disconnect to control the power provided to the converters 308 and 310. In one embodiment, the source 302 may be the single source to provide power to both the converters 308 and 310, while in another embodiment, the source 302 and a second source provide power to the converters 308 and 310. In this embodiment, the second switch 322 remains disconnected as the second source will provide power to the second converter 310. Rather, the second switch 322 connects in the situation where the second source experiences a fault to provide the power redundant to the primary output 304 to the second converter 310. The first switch 320 and the second switch 322 may be similar in structure and functionality to the first switch 220 and the second switch 222 as in FIG. 2.

The first capacitor 328 and the second capacitor 330 are electrical devices used to store energy from the power source 324. Once the capacitors are charged, the capacitors are utilized as energy sources to provide the power to converters 308 and 310. In one embodiment, the first switch 320 is to the first capacitor 328 and the second capacitor 330 is connected the second switch 322. Providing the redundant output 306, the capacitor 330 may not be used unless a second source (i.e., not pictured) providing input power to the second converter 310 fails. In this embodiment, the second switch 322 is connected to provide the redundant output 306 to the second converter 310 to compensate for the second source failure. The return paths RTN1 and RTN2 are illustrated for each respective capacitor 328 and 330.

The primary output 304 and the redundant output 306 provide power to the converters 308 and 310. The redundant output 306 (i.e., the second output) provides power similar in the amount of power of the primary output 304 to the second converter 310. For example, the primary output 304 may include 50 volts, thus the redundant output 306 may include 50 volts delivered to the second converter 310 when the second switch 322 is connected. The primary output 304 and the redundant output 306 may be similar in structure and functionality to the first output 104 and 204 and the second output 106 and 206 as in FIGS. 1-2.

The first converter 308 and the second converter 310 receive power from the source 302 on the primary output 304 and the redundant output 306. Additionally, the converters 308 and 310 are connected at their respective outputs to the load 332. In this embodiment, the converters 308 and 310 receive power from the source 302 and can increase or decrease the power as needed by the load 332. In one embodiment, the first converter 308 and the second converter 310 are DC to DC converters to achieve the load 332. In another embodiment, the outputs 304 and 306 of the source 302 are in series with converters 308 and 310, while the inputs of the first converter 308 and the second converter 310 are connected so the converters 308 and 310 are in parallel with each other. The first converter 308 and the second converter 310 may be similar in structure and functionality to the first converter 108 and 208 and the second converter 110 and 210 as in FIGS. 1-2. The first converter 308 and the second converters 310 are each connected in series with the source 302 and in parallel with each other.

The load 332 is power output connected at the outputs of the first converter 308 and the second converter 310. Embodiments of the load 332 include an electrical circuit, electrical impedance, or other type of circuit capable of being connected at the outputs of the converters 308 and 310.

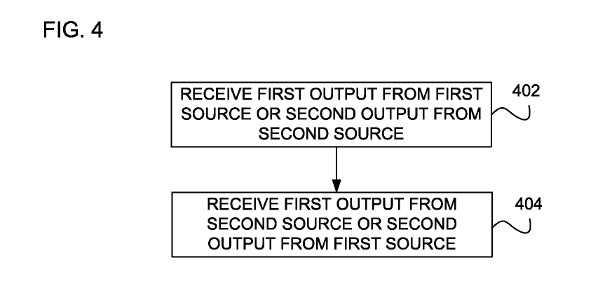

FIG. 4 is a flowchart of an example method performed on a computing device to receive by a first converter, power from either a first output from a first source or a second output from a second source. Also FIG. 4 receives by a second converter power from either a first output from the second source or a second output from the first source. Although FIG. 4 is described as being performed on a computing device, it may also be executed on other suitable components as will be apparent to those skilled in the art. For example, FIG. 4 may be implemented in the form of executable instructions on a controller, such as 218 and 318 as in FIGS. 2-3.

At operation 402, the first converter receives power from either the first output from the first source or the second output from the second source. In another embodiment of operation 402, the first converter receives input power from either the first source or the second source, but not both sources. In this embodiment, receiving power from either source enables the first converter in the power system to continue operation without interruption if one of the sources has failed. Further in this embodiment, the second output of the second source provides power that is redundant to the power of a first output of the second source. For example, the second source may include two outputs providing a primary output to power the second converter, but that power may be identical and delivered on the second output of the second source to the first converter. This example provides for the situation in which the first source may suffer a failure and/or fault. In one embodiment, operation 402 may occur prior or after operation 404.

At operation 404 the second converter receives power from either the first output from the second source or the second output from the first source. In another embodiment of operation 402, the first converter receives input power from either the first source or the second source, but not both sources. Operation 404 may be similar in functionality to operation 402. In one embodiment, operation 404 may occur prior or after operation 402.

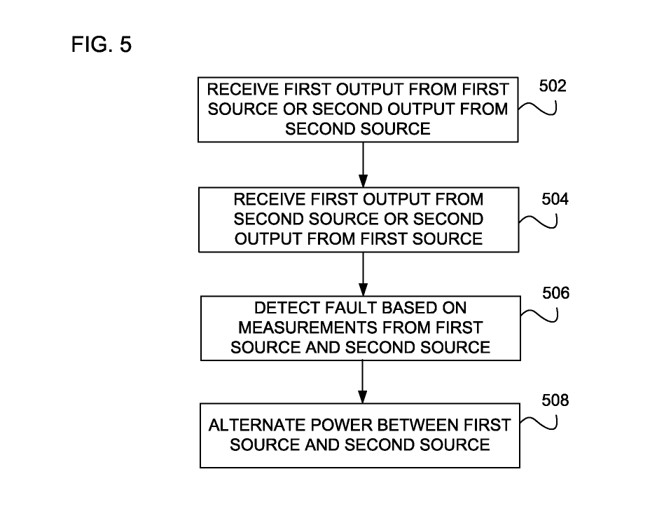

FIG. 5 is a flow chart of an example method performed on a computing device for a first converter and a second converter to receive input power from either a first source or a second source. Further, FIG. 5 also depicts an example method to detect a fault based on measurements of the first source and the second source to then alternate power to the first and the second converters based on a first and a second switch within the sources. Although FIG. 5 is described as being performed on a computing device, it may also be executed on other suitable components as will be apparent to those skilled in the art. For example, FIG. 5 may be implemented in the form of executable instructions on a controller, such as 218 and 318 as in FIGS. 2-3.

At operation 502 the first converter receives power from either the first source on the first output (i.e., the primary output of the first source) or from the second source on the second output (i.e., the redundant output of the second source). Operation 502 may be similar in functionality to operation 402 as in FIG. 5.

At operation 504 the second converter receives power from either the second source on the first output (i.e., the primary output of the second source) or from the first source on the second output (i.e., the redundant output of the first source). Operation 504 may be similar in functionality to operation 404 as in FIG. 4.

At operation 506 a controller within a power system detects a fault within the first source or the second source based on measurements from the first source and the second source. In one embodiment, operation 506 includes using sensors within the first source and the second source to measure voltage and/or current. The controller uses the measurements to determine whether the sources are experiencing a fault and/or failure. For example, the controller may obtain a 0 volts measurement from the first source which indicates the first source is experiencing a failure and/or fault.

At operation 508, power provided to the first and the second converters alternate between the first source and the second source based a first switch within the first source and a second switch within the second source. In one embodiment, operation 508 occurs once obtaining measurements to detect the fault at operation 506. In keeping with the previous example, the first source may experience a fault and/or failure, thus the controller may transmit a signal to disconnect the first switch within the first source and another signal to ensure the second switch at the second source is connected to provide power on the first and the second outputs of the second source to the converters. In another embodiment of operation 508, both the first source and the second source provide power to the converters. In this embodiment, the first output of the first source delivers primary power to the first converter and the first output of the second source delivers primary power to the second converter. Further in this embodiment, when one of the sources fail, then the switch in that respective source disconnects and the non-faulted source provides the primary power and the redundant power to the converters. In an additional embodiment of operation 508, a single source is used to provide power from the first output and the second output to the converters. In this embodiment, when that single source fails, the switch in that single source is disconnected while the switch in the non-faulted source is connected to provide the power to the converters. In these embodiments, the controller alternates the power delivered to the converters based on the switches. In a further embodiment of operation 508, the first switch within the first source and the second switch provided within the second source provide current isolation to prevent current leakage between the sources.

In summary, example embodiments disclosed herein provide redundant power to converters to increase power density and reliability while also reducing the size of the system. Further, the example embodiments disclosed herein provides current isolation to prevent current leakage among the electrical components in the power system.

We claim:

1. A system comprising:
a first source with a first output to provide input power to a first converter and a second output to provide input power to a second converter, the second output provides input power redundant to the first output;
a first converter to receive input power on the first output from the first source; and
a second converter to receive input power on the second output from the first source.

2. The system of claim 1 wherein:
the first converter and the second converter are connected in parallel to each other; and
the first source and the second source are connected in parallel to each other.

3. The system of claim 1 further comprising:
a second source with a first output to provide input power to the second converter and a second output to provide input power to the first converter, the second output of the second source provides input power redundant to the first output of the second source.

4. The system of claim 3 further comprising:
a controller to:
detect a fault at either the first source or the second source based on measurements from the first source and the second source; and
alternate the input power provided to the first converter and the second converter, between the first source and the second source based on a first switch within the first source and a second switch within the second source.

5. The system of claim 3 wherein the first source includes a first switch and the second source includes a second switch, the first and the second switches provide current isolation between the first source and the second source.

6. A source comprising:
a primary output to transmit power to a first converter;
a redundant output to transmit power to a second converter, the redundant output provides power redundant of the primary output;
a first switch to connect the primary output to the first converter input, and
a second switch to connect the secondary output to the second converter input.

7. The source of claim 6 wherein the first switch and the second switch provide current isolation between the source and a second source.

8. The source of claim 6 wherein the first converter and the second converter are connected in series with the source and in parallel with each other.

9. The source of claim 6 wherein the source is connected to a controller, the controller detects a fault within the source and transmits a signal to the source to disconnect the first switch and the second switch.

10. The source of claim 6 wherein the first switch is connected to a first capacitor to transmit power on the primary output to the first converter and the second switch is connected to a second capacitor to transmit power on the second output to the second converter.

11. The source of claim 6 wherein the first converter and the second converter are direct current (DC) to DC converters to achieve a load.

12. A method comprising:
receiving by a first converter, power from either a first output from a first source or a second output from a second source; and
receiving by a second converter, power from either a first output from the second source or a second output from the first source, the second output of the first source and the second output of the second source provides power redundant to the first output of the first source and the first output of the second source.

13. The method of claim 12 further comprising:
detecting a fault within the first source or the second source based on measurements from the first source and the second source.

14. The method of claim 12 further comprising:
alternating power, provided to the first and the second converter, between the first source and the second source based on a first switch within the first source and a second switch within the second source.

15. The method of claim 12 further comprising:
providing isolation between the first source and the second source based on a first switch within the first source and a second switch within the second source.
